(19) United States
(12) Patent Application Publication
(10) Pub. No.: US 2014/0032576 A1
(43) Pub. Date: Jan. 30, 2014

(54) Aggregation and recreation of content

(71) Applicants: Randy L. Swineford, San Jose, CA (US); Heather Devine, Sunnyvale, CA (US)

(72) Inventors: Randy L. Swineford, San Jose, CA (US); Heather Devine, Sunnyvale, CA (US)

(73) Assignee: Adobe Systems Incorporated

(21) Appl. No.: 11/521,814

(22) Filed: Sep. 15, 2006

(51) Int. Cl. G06F 17/30

(52) U.S. Cl. CPC G06F 17/3012
USPC 707/756

(57) ABSTRACT

Content aggregation and recreation techniques are presented. Metadata represents a first content and a second content. The metadata is used to generate an aggregated content, which includes both the first content and the second content. In some cases, the aggregated content is generated on demand using the current versions of the first content and the second content that are available when the aggregated content is recreated from the metadata.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be described below and in the drawings that form a part of this document: Copyright® 2006, Adobe Systems Incorporated. All Rights Reserved.

### FIELD

This application relates to data processing and in particular to techniques for aggregating and/or recreating content.

### BACKGROUND

Enterprises and individuals are increasingly producing documents in electronic formats. Electronic documents permit information to be readily modified, recalled, copied, and consumed in a near instantaneous fashion. Moreover, portable devices, such as personal digital assistants (PDA's), laptops, phones, and the like have now made electronic documents available at anyplace and anytime desired.

Not surprisingly, reliance on paper-based media is on the decline. Even important documents (e.g., legal, work related documents, etc.), which in the past were almost exclusively produced on paper and subsequently stored in filing cabinets, court libraries, safety deposit boxes, etc., are now being produced, stored, and relied upon in electronic formats.

One problem experienced with electronic documents is that an enterprise or individual may have documents in variety of data formats, such as word processing formats, graphic formats, image formats, etc. The knowledge base for any situation may necessitate that documents having different formats be brought together in order to present a desired picture of a given problem or solution. This means that the applications used for the varying data formats have to provide some conversion utility to other data formats in order for a single document to be produced that incorporates each of the varying document formats. Yet, it may be difficult to find one single application that provides conversion services for each of the document formats used.

Moreover, even assuming that one robust application is found to perform the job of converting documents to one data format, it is still highly unlikely that the task of integrating the documents into a single composite document is automated. In other words, the user has to be somewhat adept in the application to manually convert each of the varied document formats and then to tie them all together into the desired composite document. Still further, if one document is changed the entire manual process has to be repeated to get a new version of the composite document. Thus, tools for generating and managing the composite documents are unlikely to exist in applications, which may have robust conversion services.

Therefore, it is advantageous to provide techniques for aggregating and recreating content in automated fashions and in manners that are intuitive and useful to the end users.

### SUMMARY

According to an embodiment, a method for aggregating content is provided. A first reference to a first content file is received and a second reference to a second content file is received. The first and second references are defined within metadata and the metadata is subsequently used to generate an aggregated content file, which includes both the first content file and the second content file.

Other features will be apparent from the accompanying drawings and from the detailed description that follows.

### BRIEF DESCRIPTION OF DRAWINGS

Embodiments are illustrated by way of example and not limitation in the figures of the accompanying drawings, in which like references indicate similar elements and in which:

FIG. 1 is a diagram of a method for aggregating content, according to an example embodiment of the invention.

FIG. 2 is a diagram of a method for aggregating and recreating content, according to an example embodiment of the invention.

FIG. 3 is a diagram of another method for aggregating and recreating content, according to an embodiment of the invention.

FIG. 4 is a diagram of a content aggregation and recreation system, according to an example embodiment of the invention.

FIG. 5 is a diagram of an example screenshot of a Graphical User Interface (GUI) tool, according to an example embodiment of the invention.

FIG. 6 is a diagram of another example screenshot of a Graphical User Interface (GUI) tool, according to an example embodiment of the invention.

FIG. 7 is a diagram of still another example screenshot of a Graphical User Interface (GUI) tool, according to an example embodiment of the invention.

### DETAILED DESCRIPTION

In the following description, for purposes of explanation, numerous specific details are set forth in order to provide a thorough understanding of an embodiment of the present invention. It will be evident, however, to one skilled in the art that the present invention may be practiced without these specific details.

As used herein, the term “content” refers to electronic data that is consumed by viewers on displays, devices, automated services, print-based media, or page/display-based media. So, content may refer to data associated with readable text, data associated with graphics, data associated with images, data associated with spreadsheets, data associated with video, programmatic content, scripts, or data associated with various combinations of each or all of these. Some media may be page/display or view-based, such as World-Wide Web (WWW) formatted or paged media embodied in browsers and accessible over the Internet or modified via editors. Content that is logically related to form a topic, a website, a presentation, or a publication may be referred to as a “document” or a “file.”

A “sub portion” of content refers to some subset of a particular content document or file. For example, a content file represented by an Excels spreadsheet may include a specific spreadsheet or some range of columns and/or rows within a particular spreadsheet. As another example, a sub portion may include a range of pages within a content file or document. A sub portion does not have to be contiguous; so, in the prior example a content document may have a sub portion that includes pages 1, 3, and 5. It is noted that in some cases the sub portion may be contiguous; such as pages 1-5 of a content file.

The electronic data associated with the content may be represented in a variety of programming, application, or data mark-up languages, such as, but not limited to, Adobe® Portable Document Format (PDF), Hypertext Mark-up Language (HTML), Extensible Mark-up Language (XML), Extensible Style Sheets Language (XSL), Word®, WordPerfect®, JAVA®, ActiveX®, Tag Image File Format (TIFF), Microsoft Excel®, Microsoft PowerPoint®, Joint Photographic Experts Group (JPEG), Graphics Interchange Format (GIF), text format, etc.

The term “metadata” refers to data about content but not necessarily part of the content. That is, the metadata may describe characteristics or attributes about content without actually being part of the content. Examples of metadata may include but are not limited to the total number of bytes in a content file, versioning information, history information, and the like. Other examples of metadata are described herein and below.

With this context, the description of various techniques and systems for aggregation and recreation of content are now described.

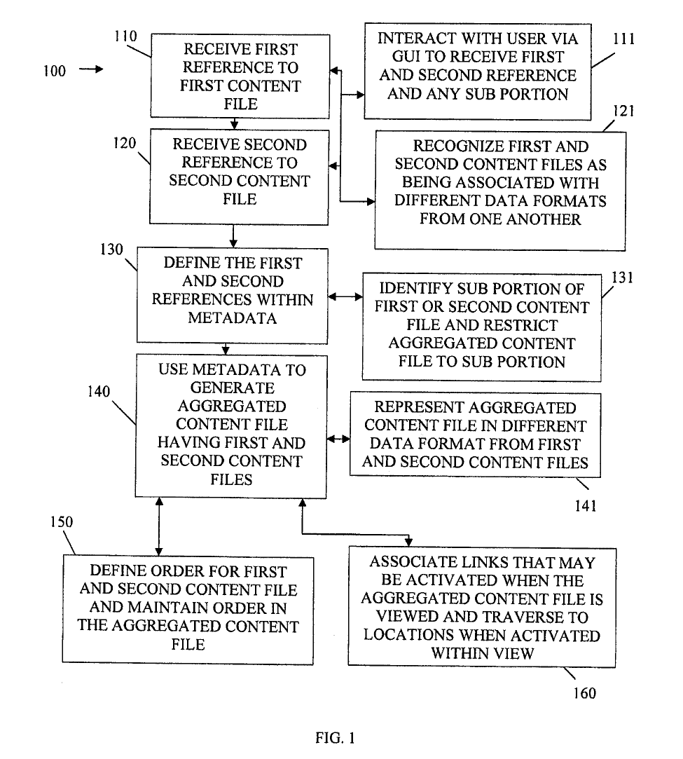

FIG. 1 is a diagram of a method 100 for aggregating content, according to an example embodiment of the invention. The method 100 (hereinafter “aggregation service”) is implemented in a machine-accessible and readable medium as instructions and is optionally accessible over a network. The instructions when accessed by a machine perform the processing depicted in FIG. 1. The network may be wired, wireless, or a combination of wired and wireless.

The aggregation service may be implemented within or callable from an existing content editor. For example, a new feature may be added to the Adobe® Acrobat® product that permits the aggregation service to be processed or called. It is to be understood, however, that the aggregation service may be a stand alone server-based or client-based service that is activated from within another service (e.g., content editor, etc.) or system or that is manually activated. It may also be network independent or network-enabled.

The aggregation service is designed to produce an aggregation of content from at least two content files. It is noted, that although the examples presented herein provide references to first content and second content, the embodiments of the invention is not limited to two content files. That is, any number of content files or selective sub portions of multiple content files may be aggregated into a single aggregated content file. Two content files are presented for purposes of illustration and comprehension only.

The technique for achieving content aggregation will now be discussed within the processing context of the aggregation service with reference to FIG. 1. Accordingly, at 110, the aggregation service receives a first reference to a first content file and, at 120; the aggregation service receives a second reference to a second content file. The references may be identifiers, such as file names, directory paths, Uniform Resource Locators (URL's), Uniform Resource Identifiers (URI's), and the like.

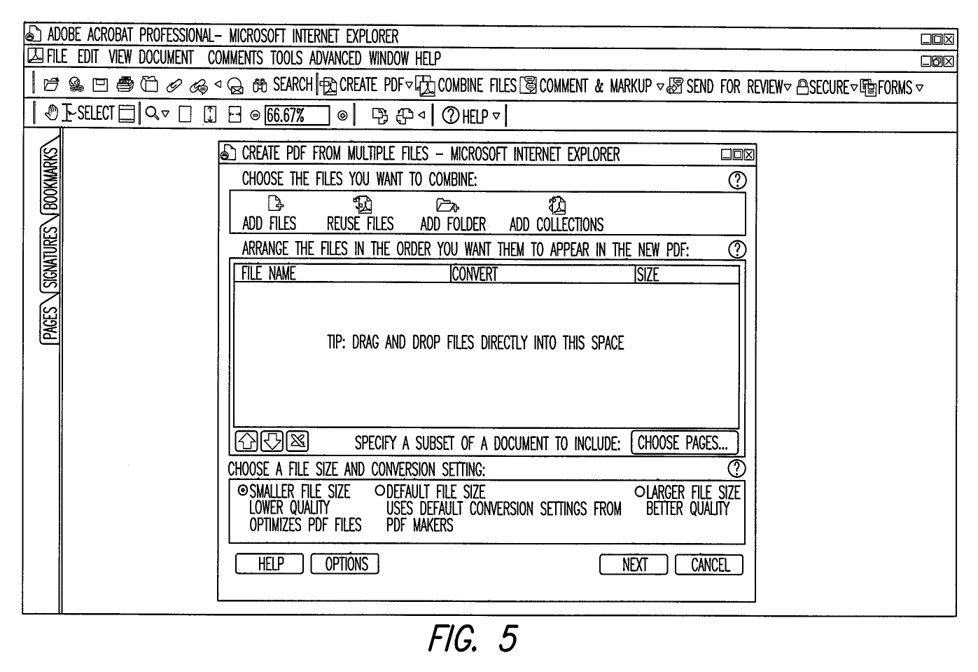

The first and second references may be received in a variety of manners. For example, at 111, the aggregation service may interact with a user via a Graphical User Interface (GUI) to receive the references, and as will be discussed more completely below to receive perhaps sub portion identifications for portions of information within the first or second content file. Some example, GUI tools and screenshots are presented below with reference to the FIGS. 5-7.

Furthermore, in some cases, at 121, the aggregation service may recognize that the first and second content files are associated with first and second data formats. In some instances, the data formats may be different. As an example, consider that the first content file is an Excel® spreadsheet and the second content file is a Word® document. In this example, the first data format is Excel® and the second data format is Word®. These are different data formats.

At 130, the aggregation service defines the first and second references within metadata. The metadata is associated with an aggregated content file that is to be generated as an aggregation of the first and second content files or from sub portions of the first or second content file as defined by a user.

In an embodiment, at 131, the aggregated may identify sub portions of the first or second content file to be represented within the aggregated content file. That is, the metadata may include limitations that instruct the aggregation service to restrict the aggregated content file to selective portions of the first and/or second content files. As was discussed with respect to the processing depicted at 111 the sub portion(s) may be identified to or received by the aggregation service via a user interacting with a GUI, where the user supplies the first and second references to the first and second content files and any desired sub portion(s) of those files.

At 140, the aggregation service uses the metadata to generate an aggregated content file having the first and second content files. The first and second references are used to acquire the data associated with the first and second content files and if necessary the first and/or second content files are converted from their native data formats into a data format associated with the aggregated content file.

According to an embodiment, at 141, the aggregated content file may be represented in a different data format from that of the data formats associated with the first and/or second content files. For example, the aggregated content file may be in PDF, whereas the first content file is in Word® data format and the second content file is in Excel® data format. It is noted, that the content files (first, second, and aggregated) may, in some cases, each be in a same data format, such as PDF. Alternatively, each may be in different data formats or two may be in the same data format where one is in a different data format. The point is, the aggregation service manages converting any disparate data format into a data format associated with the aggregated content file when one or both of the first and second content files are in different data formats from the aggregated content file.

In an embodiment, at 150, the aggregation service may also recognize and define an order for the first and second content files within the metadata and maintain that order in the generated aggregated content file. A user may via a GUI provide limitations with respect to the order. So, the second content file may actually serially appear first within the aggregated content file or vice versa depending upon limitations supplied by a user and limitations managed and maintained by the aggregation service within the metadata. It is also noted that the order may be reflected for any sub portions of the first and/or second content file, such that the order does not have to be exclusively used for a whole content file.

Additionally, in some configurations, the aggregation service may automatically define a link to the start of the first content file within the aggregated content file within the metadata. Similarly, the aggregation service may automatically define a link to the start of the second content file within the aggregated content within the metadata. These links may be user activated at a later point using the metadata for purposes of automatically navigating to the start of the first or second content file when the aggregated content file is being viewed by the user.

It may also be the case, at 160 that the aggregation service associates links within the metadata. The links identify specific user-defined locations within the first and/or second content files. The links when activated by a user viewing the aggregated content file drive the aggregation service or a sub service of the aggregation service to traverse to the locations associated with the links within the aggregated content file view. Essentially, the metadata permits limitations that function as bookmarks for the aggregated content file. The bookmarks are accessible within a content editor or viewer for the aggregated content file and permit automated traversal through portions of the aggregated content file.

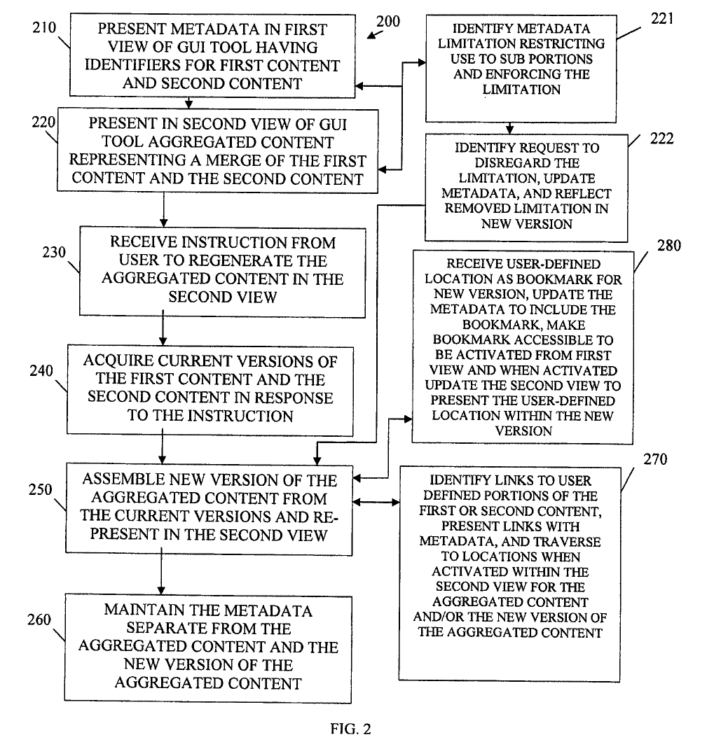

FIG. 2 is a diagram of a method 200 for aggregating and recreating content, according to an example embodiment of the invention. The method 200 (hereinafter “aggregation and recreation service”) is implemented in a machine-accessible and readable medium and is optionally accessible over a network. The network may be wired, wireless, or a combination of wired and wireless. The aggregation and recreation service presents an enhanced or alternative view of the processing associated with the aggregation service represented by the method 100 of the FIG. 1.

At 210, the aggregation and recreation service presents metadata in a first view of a GUI tool. The metadata is used to visually present identifiers for a first content and a second content. The position of the first view within the GUI tool is customizable or configurable, such that it may appear on the top of the view, to the left, to the right, at the bottom, in a center position, etc. As will be discussed more completely below the metadata may present other information within the first view as well. The first view is presented to a user, and the GUI tool provides selectable operations to use information presented with the metadata, as will also be discussed below.

At 220, the aggregation and recreation service presents a second view within the GUI tool. The second view presents aggregated content representing a merging of both the first content and the second content. So, the first view depicts the metadata and its information while simultaneously the second view presents a merged and aggregated content representing the first and second content.

According to an embodiment, at 221, the aggregation and recreation service may identify and depict specific metadata limitations, such as a metadata limitation that restricts the aggregated content to sub portions of the first and/or second content. The aggregation and recreation service also enforces the metadata limitations in the presentation associated with the aggregated content.

In some cases, at 222, the aggregation and recreation service may identify a requested operation to disregard the metadata limitation when recreating a new version of the aggregated content. When this occurs, the metadata is updated to remove the limitation, and the removed limitation is reflected in the new version of the aggregated content. So, the sub portions of a particular first or second content, which are originally reflected in the aggregated content in the second view, may be removed. As an example, suppose a user wants to just use pages 3-5 of a first content file and then decides to use every page of the first content file. The user may access an operation that removes the 3-5 page limitation and instruct the aggregation and recreation service to recreate a new version of the aggregated content where every page of the first content is presented within the second view for the aggregated content.

At 230, the aggregation and recreation service receives an instruction from a user to regenerate or recreate the aggregated content in the second view of the GUI tool. This drives the aggregation and recreation service, at 240, to acquire current versions of the first content and the second content and, at 250, to assemble a new version of the aggregated content from the current versions of the first content and second content. The new version of the aggregated content is then presented within the second view of the GUI tool.

So, if the first content is a document A and the second content is a document B, then when a user instructs the aggregation and recreation service to recreate an aggregated document identified as C, the aggregation and recreation service acquires current versions of A and B and recreates C. This is an automated procedure, such that if the data formats of A and B have to be converted to the data format of C, this is all done in an automated fashion and the user does not have to manually perform the individual conversions and perform manual file insertions into a new version of C. This can save the user a significant amount of time and effort and does not require the user to have any specific knowledge about advanced conversion features for the data format of C. These manual procedures and others are automatically processed by the aggregation and recreation service on behalf of the user when the user instructs the aggregation and recreation service to recreate the aggregated content.

According to an embodiment, at 260, the aggregation and recreation service may maintain the metadata separate and apart from the aggregated content and any new version of the aggregated content. In this manner, the aggregated content is usable and appears to the user to be any other type of content within enhanced creation and maintenance features managed via the metadata and the aggregation and recreation service.

In another embodiment, at 270, the aggregation and recreation service may identify links to user-defined portions of the first or second content from within the metadata. These links may also be presented with or in connection with selectable views associated with the metadata. When a user activates one of these links, the aggregation and recreation service traverses to the appropriate locations within the aggregated content that are associated with the activated link and the second view of the aggregated content is updated to depict the locations and the context surrounding the locations. Again, this is similar to a bookmark feature that may be managed with the metadata and used with the aggregated content. It is also again noted that the aggregation and recreation service may define and maintain its own links for subsequent user activation and use; these links may correspond to the starting locations of the first or second content within the aggregated content. So, a user may activate an aggregation and recreation service's link within the metadata to navigate to positions representing the start location within the aggregated content for either the first content or the second content.

In a similar manner, at 280, the aggregation and recreation service may identity or receive user-defined bookmarks within the metadata for the new version of the aggregated content. The metadata is then updated to reflect the bookmarks and the bookmarks are made accessible to be activated from the first view of the GUI tool. When a bookmark is activated by a user, the second view is updated to present the user-defined location within the new version of the aggregated content.

In some cases, the bookmarks may be stored or accessible via other metadata not directly associated with the first view. In other words, the bookmarks may be defined and used as links accessible from a tool bar or drop down menu within the GUI tool or within an editor or view used to present the aggregated content.

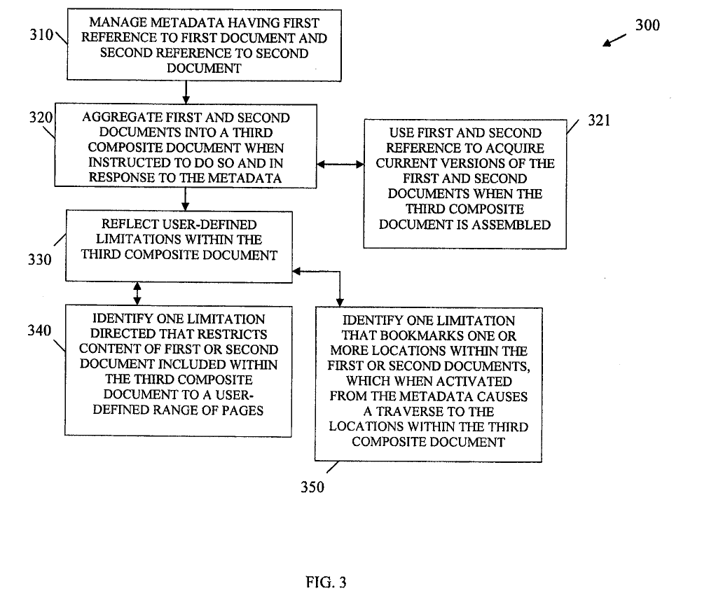

FIG. 3 is a diagram of another method 300 for aggregating and recreating content, according to an embodiment of the invention. The method 300 is implemented as instructions within a machine-accessible and readable medium and is optionally accessible over a network. The network may be wired, wireless, or a combination of wired and wireless. The instructions may implement, among other things, the methods 100 and 200 of the FIGS. 1 and 2 and provide for other beneficial features described herein and below.

The instructions may be stored on removable media and the removable media may be interfaced to a machine where the instructions are uploaded and processed to perform the processing depicted in FIG. 3. Alternatively, the instructions may be prefabricated within memory and/or storage of a machine and executed. In still other cases, the instructions may be downloaded from one network machine to another network machine and processed. In still more cases, the instructions may be executed remotely on one network machine at the direction of another network machine or its services.

At 310, the instructions manage metadata that includes at least a first reference to a first document and a second reference to a second document. The references may be file names having full directory paths or local directory paths, URL's, URI's, and the like. The references identify the documents and are used by the instructions to acquire current versions of the documents when a third composite document is created or recreated on behalf of a user or a user's direction.

At 320, the instructions aggregated the first document and the second document into a third composite document when instructed to do so. That is, at 321, the instructions use the metadata to acquire the references and the references provide a path to current versions of the documents. Once the documents are acquired they may then also be converted into a data format that is associated with or compatible with the aggregated document's data format.

At 330, the instructions may also permit and manage user-defined limitations within the third composite document. Examples of this were provided above with reference to the methods 100 and 200 of the FIGS. 1 and 2.

For example, at 340, the instructions may identify at least one limitation that directs the instructions to restrict the data content of the first or second document used to generate the third composite document to a user-defined sub portion or range of pages.

If the instructions are subsequently instructed to recreate the third composite document after a user-defined metadata limitation was created to limit the data content of the aggregated content to predefined page ranges of the data content in the first and/or second document, then the instructions may prompt or otherwise permit the user to disregard or change the metadata limitation. In this manner, the third composite document can be altered in manners the user defines each time it is recreated by the instructions.

As another example of a metadata limitation, at 350, the instructions may identify at least one limitation that bookmarks one or more locations or pages within the third composite document. These bookmarks are used for navigating the third composite document and when activated by a user direct the instructions to traverse to the locations within the third composite document. The bookmark limitation may also appear in other menus or toolbars within a GUI tool in addition to the metadata, such that a user when only viewing or editing the third composite document can navigate to previous user-defined bookmarks, create new bookmarks, or edit and change existing bookmarks.

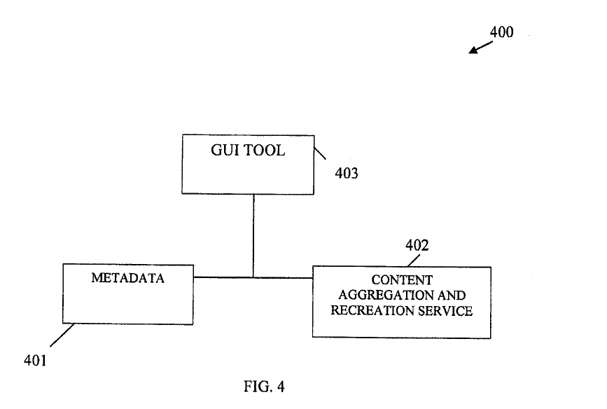

FIG. 4 is a diagram of a content aggregation and recreation system 400, according to an example embodiment of the invention. The content aggregation and recreation system 400 is implemented in a machine-accessible and readable medium and is optionally accessible or operational over a network. The network may be wired, wireless, or a combination of wired and wireless. According to an embodiment, the content aggregation and recreation system 400 implements, among other things, the methods 100, 200, and 300 depicted and described within the contexts of FIGS. 1-3.

The content aggregation and recreation system 400 includes metadata 401 and a content aggregation and recreation service 402. The content aggregation and recreation system 400 may also include a GUI tool 403. Each of these will now be discussed in turn.

The metadata 401 at least includes references to a first content and a second content. The metadata 401 may also include other user-defined limitations, such as but not limited to restrictions on sub portions to use when creating or recreating an aggregated content from the first content and the second content, bookmarks to use within the aggregated content, etc. The metadata 401 may also include other information that the content aggregation and recreation service 402 may find useful, such as data format types for the first content, the second content, and even perhaps the aggregated content. Other information may include versioning information for the first content and the second content, history information, and others.

It is also noted that the metadata 401 may be in any data format. So, in some cases the metadata 401 may be in a data format that is compatible with the data format associated with the aggregated content. In other situations, the data format of the metadata 401 may be in an independent and presentation independent data format, such as XML. In fact, any data format that is understood and recognized by the content aggregation and recreation service 402 may be used with the metadata 401.

The content aggregation and recreation service 402 manages the metadata 401 and uses the metadata 401 to perform a variety of operations. One operation is to generate, create, and/or recreate an aggregated content from the first content and the second content and from any limitations as to the specific data to use from the first content and the second content.

The content aggregation and recreation service 402 may also permit a user to alter the metadata 401 and provide user defined limitations, as discussed above. In still more situations, the content aggregation and recreation service 402 may be invoked when a user that is viewing the aggregated content attempts to activate a user-defined bookmark to navigate the aggregated content.

The content aggregation and recreation service 402 may be a standalone service or application. Alternatively, the content aggregation and recreation service 402 may be integrated into a content editor/viewer. For example, in some embodiments, the content aggregation and recreation service 402 operates as an enhanced service within the Adobe® Acrobat®, distributed by Adobe® Systems, Incorporated.

The content aggregation and recreation system 400 may also include a GUI tool 403. The GUI tool 403 interacts on the front end with a user and on the back end with the content aggregation and recreation service 402. The GUI tool 403 presents multiple views within one or more windows and allows the user to navigate and edit the metadata 401 while viewing the aggregated content or other information. Some example screenshots of a GUI tool 403 are presented below with respect to the FIGS. 5-7. In some cases, the GUI tool 403 may be viewed as an enhanced version of an existing content editor/viewer that supplies the views and features discussed herein and above.

FIG. 5 is a diagram of an example screenshot of a Graphical User Interface (GUI) tool, according to an example embodiment of the invention. It is to be understood that FIG. 5 is presented solely for purposes of illustration and the embodiments of the invention are not to be limited to any particular screenshot.

FIG. 5 illustrates an example screenshot for the GUI tool 403, which is described with respect to the content aggregation and recreation system 400 of the FIG. 4. In FIG. 5, the topmost view or frame depicts a variety of icons that permit operations, such as adding files, reusing files, adding folders, and adding collections. The middle view of frame is an area within which the results of the operations from the topmost frame may be displayed. The middle view may be considered the metadata that a user is creating for an aggregated document. The middle view will include identifiers to files, custom collections of files, previous used files, or entire folders having multiple files. The user may graphically and interactively define what appears in the middle view for purposes of defining the metadata. FIG. 5 also illustrates that the first and second content may be obtained in a variety of manners, such as via collections, reused files, entire folders, etc. It also illustrates that the metadata can be associated with more than just two documents; this point was initially made above with reference to the FIG. 1 and the method 100. Previous illustrations using two documents or files were used for purposes of ease of illustration in the descriptions above and were not intended to limit the teachings presented herein to just two documents or files.

The bottom view or frame may be used in instances where the aggregated content is a type of digital or smart document, such as PDF, or used with image types, such as TIFF, JPEG, GIF, bitmap, etc. This provides other type of metadata limitations not specifically mentioned above, such as quality and size settings for the resulting smart document or image associated with the aggregated content.

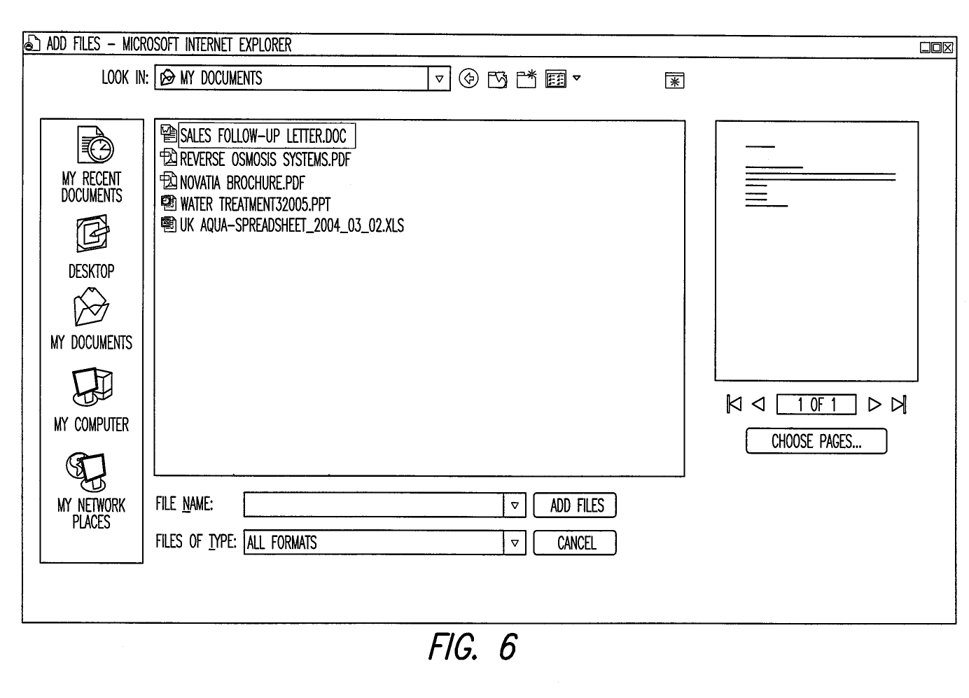

FIG. 6 is a diagram of another example screenshot of a Graphical User Interface (GUI) tool, according to an example embodiment of the invention. Again, FIG. 6 is one of many example GUI windows that may appear with the teachings presented herein. It is again presented for purposes of illustration only.

In FIG. 6 a user has browsed to a specific directory from which the user desires to view and select files to add to the metadata, which will be subsequently used to create, generate, or recreate an aggregated document. The left view depicts the files present in a particular directory that the user is viewing. In the example screenshot, the user has highlighted or selected a file named “Sales Follow-Up Letter.doc.” The right view shows a preview of the data contents associated with that selected file for ease of viewing. Also, in the right view on the bottom is a button labelled “Choose Pages . . .” the user may select this to further edit and provide a user-defined sub portion limitation on the pages that are to be used in the aggregated document from the selected file. So, as was highlighted above the user does not have to use the entire selected file in the aggregated document that will be generated (although if desired this could be the case); rather, the user can selectively pick pages or ranges of pages to include in the aggregated document.

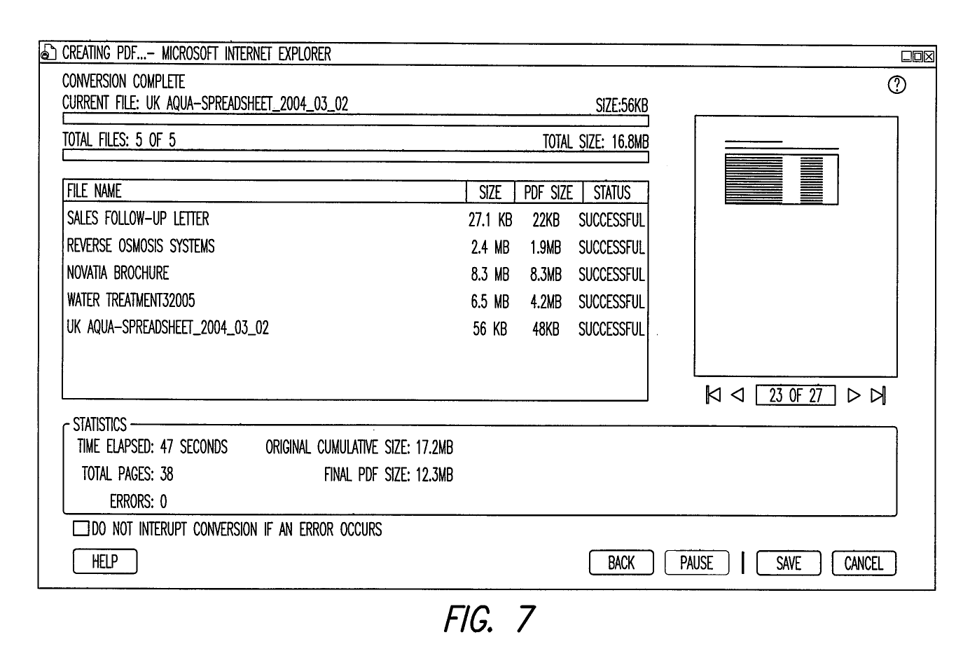

FIG. 7 is a diagram of still another example screenshot of a Graphical User Interface (GUI) tool, according to an example embodiment of the invention. FIG. 7 is yet another illustration that is not intended to be used as a limitation on the teachings presented herein.

In FIG. 7, the references to the files that are to be used to generate an aggregated document are depicted on the left along with their names or descriptions. The left also shows whether these files were successfully added to the aggregated document. A progress bar shows the overall conversion status associated with converting all of the files into the aggregated document and associated with a particular file being currently converted. The bottom shows statistics or metrics associated with the converting the files from their native data formats to a data format associated with the aggregated document. The right shows a particular page being processed or viewed by the user within the aggregated content that was generated.

It is to be understood that a variety of other features and windows may be added to the GUI tool 403 without departing from the teachings presented herein. For instance, a window may show packages that represent previous aggregated documents. The packages may have a single reference for ease of reuse but include a plurality of files. In this manner, a user may construct new aggregated documents that include other previous aggregated documents that were labelled and stored as packages. When generating an aggregated or merged document, the user may also have windows that permit the merged document to be labelled as a package for subsequent reuse by others.

The above description is illustrative, and not restrictive. Many other embodiments will be apparent to those of ordinary skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving a first uniform resource identifier identifying a first content file that is accessible over an Internet;
receiving a second uniform resource identifier identifying a second content file that is accessible over the Internet;
defining the first and second uniform resource identifiers within metadata;
generating an aggregated content file that includes both the first content file and the second content file using the metadata;
receiving instruction to regenerate the aggregated content file;
regenerating a new version of the aggregated content file using the metadata based on the receipt of the instruction, the metadata being maintained separate from the aggregated content file and from the new version of the aggregated content file.

2. The method of claim 1 further comprising, recognizing the first content file as being a first document associated with a first data format and the second content file as being a second document associated with a second data format, wherein the first data format is different from the second data format.

3. The method of claim 2, wherein the generating the aggregated content file further includes representing the aggregated content file in a third data format that is different from the first and second data formats.

4. The method of claim 1 further comprising:
identifying a sub portion of either the first content file or the second content file within the metadata; and
restricting the aggregated content file to include the sub portion without remaining portions of the first content file or the second content file.

5. The method of claim 4 further comprising, interacting with a user via a Graphical User Interface (GUI) to receive the first uniform resource identifier, the second uniform resource identifier, and the sub portion.

6. The method of claim 1 further comprising, defining an order for the first content file and the second content file within the metadata, wherein the order is maintained in the aggregated content file.

7. The method of claim 1 further comprising, associating links that may be activated when the aggregated content file is viewed, wherein a first one of the links when activated traverses to a view of the aggregated content file depicting the first content file and wherein a second one of the links when activated traverses to another view of the aggregated content file depicting the second content file.

8. A method, comprising:
presenting metadata in a first view of a Graphical User Interface (GUI) tool, the metadata being used to present uniform resource identifiers for a first content and a second content that are accessible over an Internet;
presenting in a second view of the GUI tool an aggregated content representing a merging of both the first content and the second content;
receiving instruction from a user to regenerate the aggregated content in the second view;
acquiring current versions of the first content and the second content based on the uniform resource identifiers in response to the instruction; and
assembling a new version of the aggregated content from the current versions and representing the new version within the second view of the GUI tool.

9. The method of claim 8 further comprising, maintaining the metadata separate from the aggregated content and the new version of the aggregated content.

10. The method of claim 8, wherein presenting the metadata further includes identifying the first content or the second content as having a metadata limitation that restricts use of the first content or second content to sub portions of the first content or the second content within the metadata, and wherein the metadata limitation is enforced with the aggregated content presented within the second view of the GUI tool.

11. The method of claim 10, wherein receiving the instruction further includes:
identifying a request within the instruction to disregard the metadata limitation;
updating the metadata to reflect the removal of the metadata limitation; and
reflecting the removed metadata limitation within the new version of the aggregated content re-presented within the second view of the GUI tool.

12. The method of claim 10, wherein receiving the instruction further includes:
identifying a request within the instruction to alter the metadata limitation to include other sub portions of the first content or the second content;
updating the metadata to reflect a new metadata limitation; and
reflecting the new metadata limitation within the new version of the aggregated content re-presented within the second view of the GUI tool.

13. The method of claim 8 further comprising:
identifying links to user-defined portions of the first content or the second content within the metadata;
presenting the links within the metadata in the first view of the GUI tool; and
traversing to corresponding locations within the new version of the aggregated content in the second view of the GUI tool when one or more of the links are activated from the first view of the GUI tool.

14. The method of claim 8 further comprising:
receiving a user-defined location from within the new version of the aggregated content of the second view as a bookmark within the new version of the aggregated content;
updating the metadata to include the bookmark; and
making the bookmark accessible to be activated from the first view of the GUI tool and when the bookmark is activated updating the second view to present the user-defined location within the new version of the aggregated content.

15. A machine-accessible medium having instructions included thereon, the instructions when accessed by a machine perform a method, the method comprising:
managing metadata that comprises a first uniform resource identifier identifying a first document and a second uniform resource identifier identifying a second document, the first and second documents being accessible over an Internet;
aggregating the first document and the second document into a third composite document when instructed to do so and in response to the metadata, the metadata being maintained and managed separate from the third composite document;
receiving instruction to regenerate the third composite document based on user-defined limitations; and
regenerating, using the metadata, a new version of the third composite document with the user-defined limitations based on the receipt of the instruction.

16. (canceled)

17. The medium of claim 15 further comprising instructions to identify at least one limitation that restricts content of the first document or the second document, which is to be included within the new version of the third composite document, to a user-defined range of pages.

18. The medium of claim 15 further comprising instructions to identify at least one limitation that bookmarks one or more locations within the first or second document, and wherein the bookmarks can be activated from the metadata to traverse to the one or more locations within the third composite document.

19. The medium of claim 15, wherein aggregating further includes using the first uniform resource identifier and the second uniform resource identifier to acquire current versions of the first document and the second document when assembling the third composite document.

20. A system, comprising:
a memory to store metadata and a content aggregation and recreation service,
wherein the metadata is managed by the content aggregation and recreation service and includes uniform resource identifiers to a first content and a second content that are accessible over an Internet, and wherein the content aggregation and recreation service is to generate aggregated content that includes current versions of the first content and second content when instructed to do so.

21. (canceled)

22. The system of claim 20, wherein the metadata includes a limitation that restricts the aggregated content to predefined sub portions of the first content or the second content, and wherein the limitation is enforced and managed by the content aggregation and recreation service.

23. The system of claim 20, wherein the metadata includes a link that when activated by a user traverse to a specific location within the aggregated content, and wherein the link is processed and managed by the content aggregation and recreation service.

24. The system of claim 20, wherein the aggregated content is a document in a Portable Document Format (PDF), and wherein the first content and second content are other documents in a data format selected from a group of data formats including a word processing data format, a World-Wide Web (WWW) data format, an Extensible Markup Language (XML) data format, an image data format, a spreadsheet data format, a presentation data format, a graphic data format, a text data format, and a printer compatible data format.
